(19) United States
(12) Patent Application Publication
(10) Pub. No.: US 2015/0098018 A1
(43) Pub. Date: Apr. 9, 2015

(54) TECHNIQUES FOR LIVE-WRITING AND EDITING CLOSED CAPTIONS

(71) Applicant: NATIONAL PUBLIC RADIO, Washington, DC (US)

(72) Inventors: Michael Irving STARLING, Cambridge, MD (US); Samuel GOLDMAN, Brooklyn, NY (US); Ellyn SHEFFIELD, Phoenix, MD (US); Richard RAREY, Kensington, MD (US)

(73) Assignee: NATIONAL PUBLIC RADIO, Washington, DC (US)

(21) Appl. No.: 14/046,634

(22) Filed: Oct. 4, 2013

(51) Int. Cl. H04N 7/088

(52) U.S. Cl. CPC H04N 7/0882
USPC 348/468

(57) ABSTRACT

Techniques for live-writing and editing closed captions are disclosed. In one particular embodiment, the techniques may be realized as a method for generating captions for a live broadcast comprising the steps of receiving audio data, the audio data corresponding to words spoken as part of the live broadcast; analyzing the audio data with speech recognition software in order to generate unedited captions; and generating edited captions from the unedited captions, wherein the edited captions reflect edits made by a user. All of these steps may be performed during the live broadcast.

### FIELD OF THE DISCLOSURE

The present disclosure relates generally to automated speech recognition and, more particularly, to techniques for adding closed captions to broadcast media.

### BACKGROUND OF THE DISCLOSURE

In the United States alone, nearly 50 million people are deaf or hard of hearing, and it is estimated that one half of these people are unable to enjoy radio broadcasts, monitor emergency information disseminated by audio, or otherwise use devices that play audio recordings and files. Providing timely and accurate captions can aid the hard of hearing in accessing information flow as well as the audibly abled.

However, broadcast content is normally spoken at a rate between 180 and 250 words per minute. Automated live-writing, voice-writing, or recognition systems may provide a first-level approximation of the text of a broadcast, but it is usually necessary to significantly edit captions resulting from automated speech recognition systems. Traditional live-writing systems, voice-writing systems, and caption editing methods and devices utilize traditional stenographic methods, and as such the availability and efficacy of caption editing methods depend significantly on the quantity and quality of available trained human stenographers. News radio and other live broadcasts, for which a single captioner must serve as editor, do not have the luxury of pausing the audio feed. Thus, efficiency and accuracy are a constant challenge, but are also of utmost importance for usability and sustainability.

In view of the foregoing, improvements to live-writing, voice-writing, and caption editing systems are desired.

### SUMMARY OF THE DISCLOSURE

Techniques for live-writing and editing closed captions are disclosed. In one particular embodiment, the techniques may be realized as a method for generating captions for a live broadcast comprising the steps of receiving audio data, the audio data corresponding to words spoken as part of the live broadcast; analyzing the audio data with speech recognition software in order to generate unedited captions; and generating edited captions from the unedited captions, wherein the edited captions reflect edits made by a user. All of these steps may be performed during the live broadcast.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 is a diagram representing a caption generation system in accordance with some implementations of the present disclosure.

FIG. 1A illustrates a display associated with an interface for injecting words into captions during re-speaking in accordance with some implementations of the present disclosure.

FIG. 2 illustrates a control node along with particular functions and features thereof in accordance with some implementations of the present disclosure.

FIG. 3 illustrates a display associated with a caption editing interface in accordance with some implementations of the present disclosure.

FIG. 4 illustrates a transcription system including a transcription editing interface in accordance with some implementations of the present disclosure.

FIG. 5 shows an exemplary method for generating closed captions in accordance with some implementations of the present disclosure.

### DETAILED DESCRIPTION OF EMBODIMENTS

Although many of the embodiments described herein refer to an integrated system for live-writing and editing captions, particularly as applied to live and pre-recorded audio and video for broadcast, it will be understood that elements of the system may be used independently or in various combinations under a variety of conditions. One of ordinary skill will recognize how to apply techniques and features described herein to captioning systems for recorded media, for live venues including performances and speeches, for educational purposes (classrooms, lectures, audio/visual screenings, graduation ceremonies and the like), and others as understood in the art.

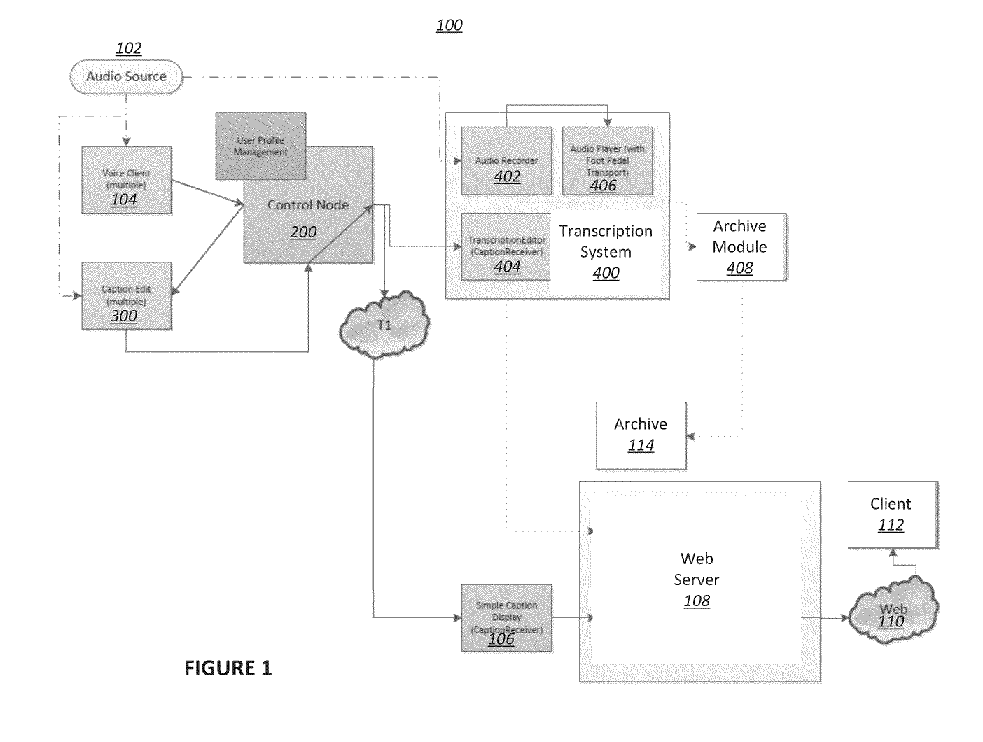

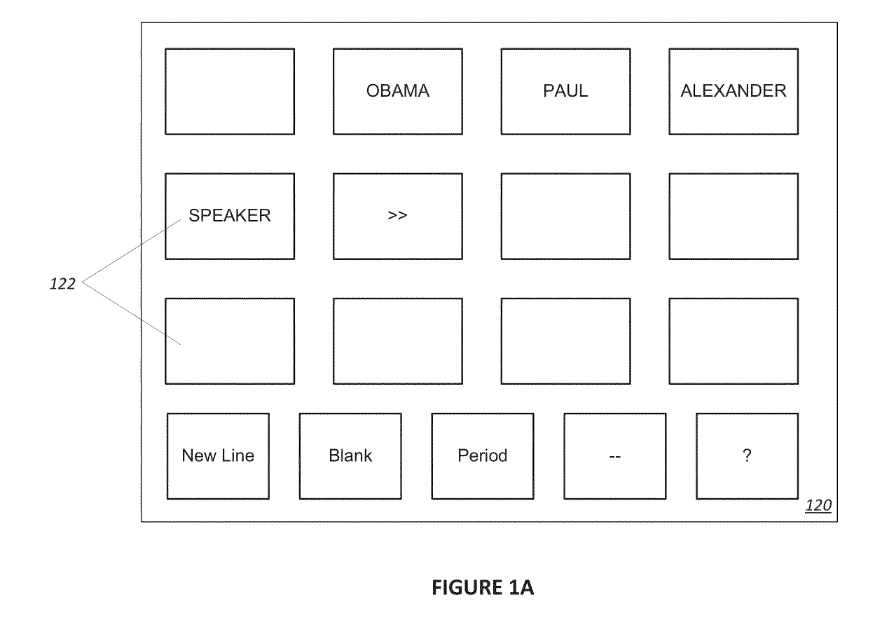

FIG. 1 is a diagram representing a caption generation system 100 in accordance with some exemplary implementations of the present disclosure. Various features of the caption generation system 100 represent improvements in captioning technology which assist in generating live, or “virtual live”, captions and transcriptions.

The caption generation system 100 may include an audio source 102, which may represent a feed from a live broadcast or prerecorded segment. In some implementations, the audio source 102 may include a re-speaker responsible for repeating live text heard from another audio source 102. Adding re-speaking to the process may increase the accuracy of speech recognition (particularly with content containing background music, on-location sounds, multiple speakers, foreign accents, and so forth). The re-speaker may be specifically selected to be easily understood by one or more voice clients, and the re-speaker may have performed one or more attuning steps with speech recognition software in order to further increase accuracy.

For example, a speech recognition system may be able to record the re-speaker saying known words or phrases, which allows the system to analyze aspects of the speaker's pronunciation. One of ordinary skill in the art will recognize additional attuning and learning steps that can be performed by a speech recognition system to accurately transcribe the speech of a known user, which can be used to the benefit of a re-speaker output stream. An example of speech recognition software which includes features allowing the system to adapt to profiles of particular users is sold under the DRAGON™ speech recognition brand, available from Nuance Communications, Inc. In some implementations, using a re-speaker in association with live-writing of broadcast audio will allow a system to take full advantage of these speech recognition features.

One or more voice clients 104 may receive audio signals from the audio source 102 and may convert the signals into digital voice data formatted for analysis and conversion by other components of the system 100. A voice client 104 may be any computer program or module equipped to receive the audio signals from the audio source 102 and determine the data from the source that needs to be included in formatted audio data. In some implementations, the voice client may be an integral component of audio recording or speech recognition software as used in other components of the caption generation system 100.

In some implementations, the voice client 104 may be configured to accommodate a re-speaker as described above along with an interface 120 as shown in FIG. 1A. The interface 120 may be a touch-screen display or may include a mouse or other input means. As shown, the interface 120 may include buttons 122 that the re-speaker can select while repeating words heard during a live broadcast.

As shown, the buttons 122 may include speaker names (which may be drawn from as speaker list associated with a caption database or custom caption data as further described below). In some implementations, the re-speaker may select a button 122 with a speaker's name in order to add the selected name to the captions at that point (and perhaps also select a clarifying character such as the “>>” shown on the display 120 to appear immediately after the selected name). Similarly, the re-speaker may be able to help format the captions by adding punctuation or indicating a line break at certain points in the caption by selecting the appropriate button 122 from the interface 120.

In some implementations, the display of a button 122 may not necessarily be the same as the word or words that is inserted into the captions when the button is pressed. For example, some buttons 122 may include an image, such as a picture of a speaker. Selecting an image may cause a particular caption associated with that image to be inserted, such as the speaker's name in the case of a picture of a speaker. As an additional example, text on a button 122 could be abbreviated relative to the actual inserted caption text.

The caption generation system 100 may include a control node 200 that receives voice data from one or more voice clients 104 and provides functions and services associated with generating captions. In some implementations, the control node 200 may include speech recognition software, voice recognition software, user profiles, scheduling software, program-specific captioning profiles, and other modules and features further described below.

The control node 200 may communicate with one or more caption edit interfaces 300 configured to receive unedited captions from the control node 200 and allow users to edit those captions. Each caption edit interface 300 may be an application running on a computer system, and may include a display, keyboard, and other components. Further description of implementations of a caption edit interface 300 is included below. The control node 200 may receive edited captions from the one or more caption interfaces 300.

Edited captions received by the control node 200 may be further modified by the control node 200, such as by providing additional metadata, scheduling, or other information. The control node 200 may convert data received from the caption edit interfaces 300 into other formats as necessary.

Edited captions may then be sent to a caption receiver module 106 which, in some implementations, may be associated with a web server 108. The web server 108 may include additional modules to allow for streaming of caption content. In some implementations, caption content associated with a radio broadcast may be streamed “live.” The web server 108 output may be accessible over a network 110, such as the Internet, so that audience members may read the caption content through use of an end-user client 112, such as a web browser, various tablets or other rendering devices, or other text-displaying devices such as a refreshable braille display. In some implementations, the web server 108 may also make additional caption content for download, such as caption content associated with pre-recorded broadcasts or past live broadcasts. In addition, the web server 108 may integrate system-produced content with geographically or other affinity-based content (weather icons, temperature, sponsorship, station logos, promotional information, and the like) for the end-user client 112.

The audio source 102 may also send signals to an audio recorder 402 associated with a transcription system 400. The transcription system 400 may be equipped with a transcript editing interface 404, which in some implementations may receive caption data from the control node 200, and an audio player 406 for controlling playback of audio data captured by the audio recorder 402. In some implementations, the transcript editing interface 404 and audio player 406 may both be associated with a particular computing system configured to allow for convenient transcription editing by a user, as further described below.

Once a finished, edited transcript is produced, it may be sent to an archive module 408, which may modify or convert the edited transcript for storage in an archive 114 in one of a wide variety of archival formats (such as DAISY or timed text mark-up language (TTML)). Audio files may also be stored in an archive 114, and in some implementations, the archive module 408 may associate particular audio files in synchronized or synchronization-ready forms with their transcripts for later retrieval and use.

In some implementations, the contents of the archive 114 may be available on the web server 108 or on a different web server. There may be permissions in place such that some or all of the contents of the archive 114 may only be accessible to certain authorized users. In some implementations, certain files may be publicly accessible from a web site or other network location and may be able to be downloaded or streamed by means of an end-user client 112. The end-user client 112 may be fed by scheduled, customized, live or recorded content as requested by users and governed by the service provider.

Although FIG. 1 illustrates a particular configuration for components and modules, it will be understood that different configurations are possible. It should also be understood that descriptions of systems and modules herein are not necessarily limited to a single physical system or location. For example, the archive 114 may be implemented on one or more local or network storage locations. The web server 108 may be implemented as a variety of servers with different network locations providing different services and access patterns. Lines of communication shown on the chart may represent local or remote connections, and connections may be persistent or intermittent. Files and data may be transferred, stored, and executed using a variety of equipment and methods as known in the art.

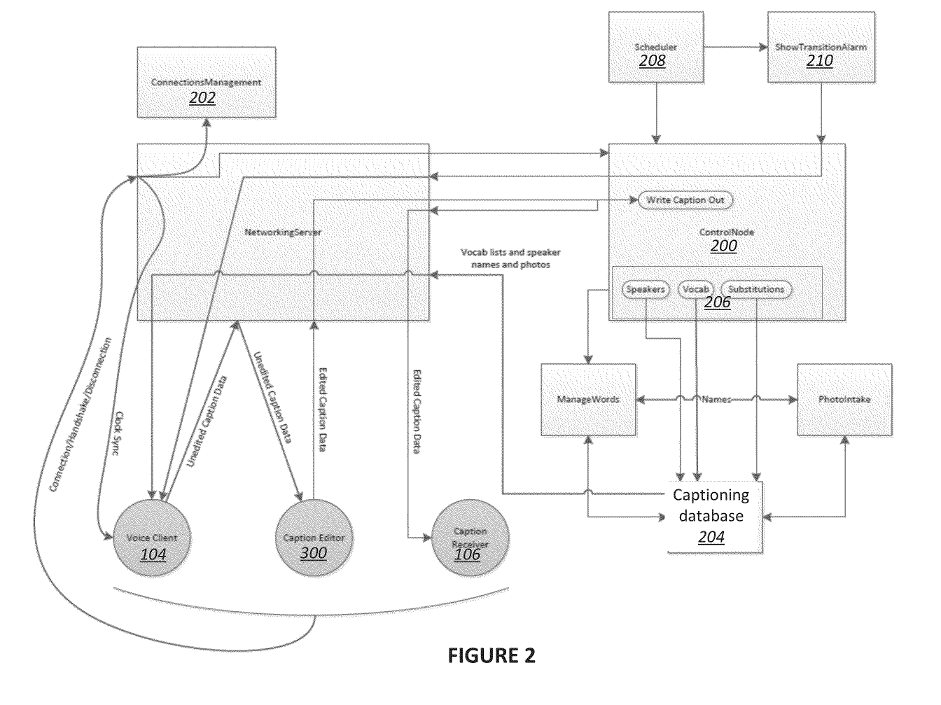

FIG. 2 illustrates an implementation of a control node 200 along with particular functions and features thereof. As illustrated, the control node 200 may include a connections management module 202 which may interface with one or more voice clients 104, caption editing interfaces 300, and caption receivers 106 as discussed above. In some implementations, communication between these different components of the system 100 may be mediated by a networking server.

As illustrated in FIG. 2, in some implementations, unedited caption data may be sent by the voice client 104 and received by the caption editor 300, which may in turn send edited caption data to the control node 200. The control node 200 may modify the caption data both before and after it is edited by means of the caption editor 300, as necessary. The edited caption data is then sent to the caption receiver 106 for further dissemination.

The control node 200 may include various tools which may affect the automated live-writing process. For example, in some implementations, the control node 200 may be responsible for managing a captioning database 204 used in generating the unedited caption data and switching between multiple voice clients.

The captioning database 204 may include a vocabulary list that includes the pronunciations of a variety of words. The vocabulary list may include the spelling and pronunciation of most words that are expected to be commonly used in whatever context the control node 200 is using the database 204. In some implementations, the vocabulary list may come from a list of words used by an auto-correct, spell-checking, or speech recognition program, or program run-downs, as further customized by one or more users.

In some implementations, the lists associated with the captioning database 204 may be stored in a form which is accessible users, such as a spreadsheet. The control node 200 may manage an interface by which users can add, modify, or remove words from the vocabulary list, possibly in response to repeated necessary edits during the caption process.

In addition to the vocabulary list, the captioning database 204 may include a names list which includes correct spelling and pronunciation for names that are expected to be captioned. In some implementations, the names list may be managed separately from the general vocabulary list because, if the database 204 includes a large collection names that are no longer needed, this may negatively impact the quality of the captioning as too many of these names may be erroneously recognized.

Each name on the names list may be associated with a time stamp reflecting when a name was entered onto the names list. The system may include a method of recognizing when a name already on the list is entered again and updating the time stamp rather than creating a duplicate entry. When the time stamp of a name exceeds a threshold age, the name may be removed from the list. In some implementations, other criteria (such as the selection of the name for substitution during caption or transcript editing) may also influence whether a name remains on the name list for use in the captioning database 204 or is removed. By automatically removing unused or rarely-used names from the captioning database 204, the accuracy and efficiency of the live-writing captions may be increased.

The captioning database 204 may further include a speaker list, a list of individuals to whom spoken words are assigned within the caption system in order to provide context to the caption reader. In some implementations, the captioning database 204 may include a list of on-air talent and regular contributors who are often heard on broadcasts. The names on the speaker list may be particularly tailored for attribution in captions; some names may be only a first or last name, or may include a title (e.g., “Dr. Smith” or “Sen. Jones”). In some implementations, the speaker list may be used to automatically populate the re-speaker interface 120 for the selection of speakers as described above with respect to FIG. 1A.

As part of managing the captioning database 204, the control node 200 may manage the use of custom caption data 206, which may be associated with a particular segment of programming. The custom caption data 206 may include a speaker list, vocabulary list, and name list that provides additions or modifications to the captioning database 204 on demand or in advance as the program associated with the custom caption data 206 is being captioned.

For example, a particular science show or segment may include specialized scientific terminology and may often refer to some particular experts in science who are not otherwise newsworthy. Custom caption data 206 may be generated for this science show or segment, including the specialized scientific terminology on the vocabulary list and the experts on the names list. When the science show or segment is being captioned, the custom caption data 206 is included so that those words and names are recognized, without having these unusual words and names mistakenly recognized when captioning other shows or segments.

As another example, a political show or segment may include commentary by several different contributors who are unique to that program. Those contributors may be included on a speaker list in custom caption data 206 unique to that show or segment, so that they are available for caption attribution when that particular show or segment is running but do not clutter the speaker list at other times.

In some implementations, the control node 200 may include a scheduler 208 that manages transitions between different custom caption data 206. The scheduler 208 may be synchronized with a broadcast schedule associated with the radio broadcast being captioned, so that the control node 200 can automatically transition between sets of custom caption data 206 in coordination with the movement between segments within the broadcast. For example, when the broadcast schedule indicates that the science show or segment mentioned above has ended and the political show or segment is starting, the control node 206 may automatically remove the custom caption data 206 associated with the science show or segment from further consideration and include the custom caption data 206 associated with the political show or segment instead.

An alarm module 210 may communicate with the scheduler to signal to users, such as caption editors, when a transition between segments that will alter the custom caption data 206 is taking place. This “alert” of a change in custom caption data 206 provides confirmation to the caption editor that specialized terms and names are anticipated.

In some implementations, the custom caption data 206 may be stored in editable and reusable schedule files, which may also be extensible for additional metadata fields.

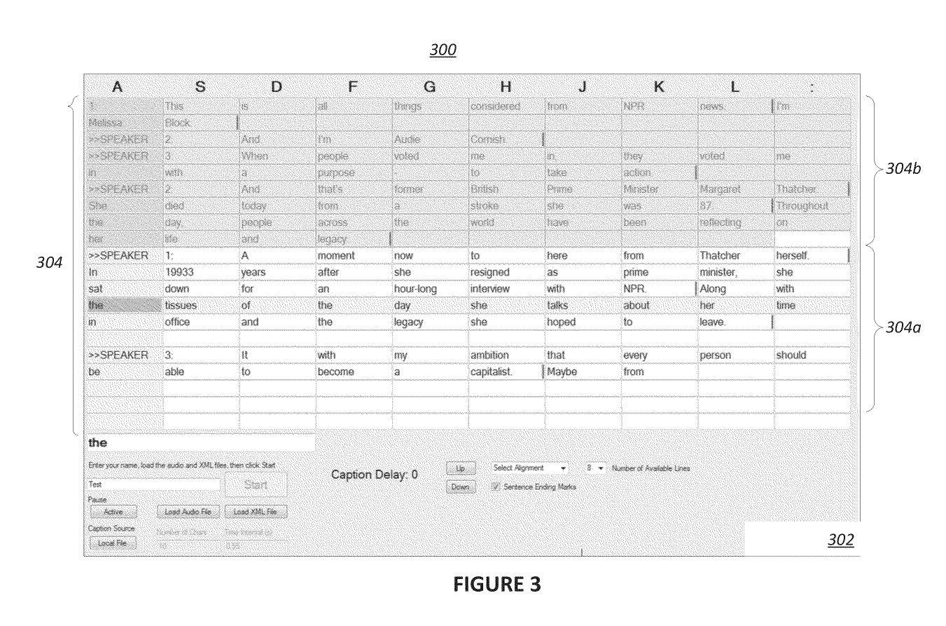

FIG. 3 illustrates a display 302 associated with a caption editing interface 300. In some implementations, the caption editing interface 300 is configured so that, during editing of captions for a live broadcast, the user can edit the captions using only keystrokes associated with a keyboard (not shown) so that the editor does not have to make significant arm and hand movements, such as moving a mouse, typing long commands, etc., which could reduce editing speed.

The display 302 includes a word grid 304 showing the captioned words. In one embodiment, the word grid 304 is a grid with ten columns and ten rows, and each cell in the grid contains a word that has been recognized by the voice recognition software. Thus, the grid 304 may include only ten places for words in each row so that each word corresponds to one key in the keyboard home row (i.e., keys “A,” “S,” “D,” “F,” “G,” “H,” “J,” “K,”, “L,” and “;” when using a traditional “QWERTY” keyboard configuration), although it will be understood that other keyboard configurations are known in the art).

The word grid 304 includes ten columns, such that increments of ten words are displayed on the editing display 302 in each row. As words are recognized by the voice recognition software, each cell of the bottom row of the grid 304 is populated with the recognized words. When the bottom row is filled up, the words in the bottom row are moved up to the adjacent row in the grid 304 so that additional words that are recognized by the voice recognition software populate the bottom row. This process continues, with rows of words being incrementally moved up a row at a time on the grid 304 until the top row is populated with words. When the voice recognition software continues to recognize new words, the top row of words is moved “up and off” of the grid 304.

As shown in FIG. 3, the word grid 304 may include an editing zone 304a and a released zone 304b. As rows scroll up and words move from the editing zone 304a into the released zone 304b, those words are output for display as part of the edited caption, so that the words can be streamed “live” as described above with respect to FIG. 1. In some implementations, the number of rows provided within the editing zone 304a is customizable. While more rows provide additional editing time and commensurate “buffer” delay while editing (that is, there is more time to edit each word because each row spends more time in the editing zone 304a), fewer rows provide output that is closer to real-time output.

In some implementations, each key on the home row may be associated with one of the ten columns. The active row may be changed by using another key on the keyboard or other ergonomic input. Specific keys or other ergonomic input (such as foot pedals) may be assigned to automatically put an active cursor at the beginning of a selected word, at the end of a selected word, or to delete a word entirely and accept further keystrokes to replace it with a different word.

In one particular implementation, when the caption editor wants to change a specific word, the editor presses the home row key that corresponds to the column containing that grid cell. For example, if the word that needs to be edited is in the fifth cell from the left, then the editor would press the “G” key to access that column.

Because there are three rows of cells available, the editor may have to select which cell within the “G” column contains the word to be edited. The editor may navigate the cell selection cursor up or down (“U” to move the cell selection cursor up one row, and “N” to move down one row) within the available editable cells of that column until the desired word is selected. Other means of rapid navigation can be achieved by those skilled in the art.

In one implementation, once the cell selection cursor is highlighting the correct cell, the editor can edit the cell in three different ways. The editor can press the “Q” key to place a text entry cursor at the front of the text of the cell, which allows the editor to add or modify letters at the beginning of the word. The editor can instead press the “P” key to place a text entry cursor behind the text of the cell, which allows the editor to add or modify letters at the beginning of the word.

The editor can also press the space bar, which erases the contents of the cell and places a text entry cursor in the cell so that the editor can type an entirely different word into the cell.

Once the editor presses either the “Q”, “P”, or space bar key to place a text entry cursor, the keyboard acts as a normal keyboard. Further key presses enter text into the cell. Once the editor has corrected the cell, pressing the “Enter” key saves the edits.

After the editor presses the “Enter” key to save any edits to the cell, the text entry cursor disappears and control is returned to the cell selection cursor. Further key presses will again move the cell selection cursor between rows and columns in order to highlight another cell that needs to be edited. This allows the editor to quickly jump from one correction to the next.

Further, single strokes may be pre-assigned to particular words that are repeatedly mis-read by the automatic speech recognition process. In some implementations, selecting a particular word and then making the appropriate keystroke may automatically replace the word with the pre-assigned substitution word.

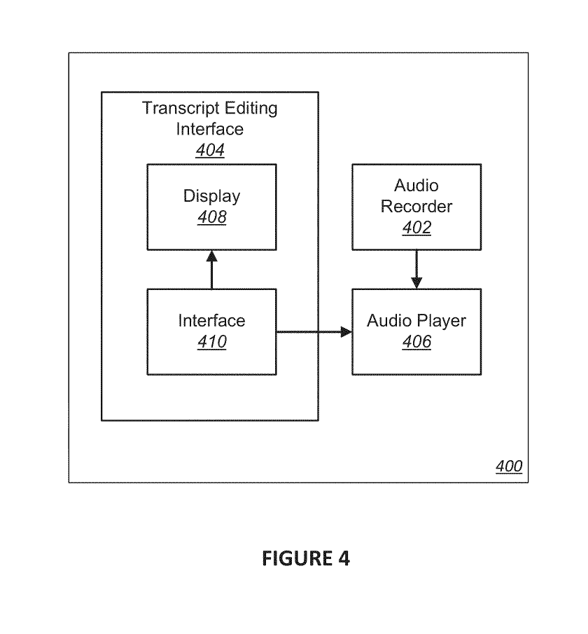

FIG. 4 illustrates a transcription system 400 including a transcript editing interface 404. In some embodiments, the transcript editing interface 404 may have some or all of the features described above with respect to the caption editing interface 300. Alternatively, the transcript editing interface 404 may be configured differently to reflect the emphasis on precision rather than speed.

Unlike the word grid 304 described above for the caption editing interface 300, the transcript editing interface 404 may include a display 408 with a larger number of rows and the ability to manually select any rows within the transcript, to reflect the ability of the transcript editor to freely move back and forth within the recorded audio data without time restraints. The transcript editing interface 404 may also include an interface 410 for the audio player 406 that allows the transcript editor to control playback of the audio data. The purpose of these interfaces is to give the transcription system 400 more time to analyze, verify and correct the text coming from the caption editing interface 300 without disturbing or otherwise affecting the workflow.

In some embodiments, the transcript editing interface 404 may be different from the caption editing interface 300, and may function, look, and feel more like a traditional word processor to the user, including the ability navigate using a mouse, arrow keys, or other standard word processor controls. Some implementations may lack some of the efficiency components, such as the word grid and unusual keyboard navigation scheme, described above with respect to the caption editor 300. The display 408 may include an audio controller interface which may be used in conjunction with or instead of the interface 410 in controlling the audio player 406; the audio controller interface may look like a very traditional media player.

In some implementations, the interface 410 may be one or more foot pedals, allowing the transcript editor to control the playback of audio data while the hands are occupied with editing the transcript. In one implementation, a single foot pedal assembly with three footswitches may be used. Depressing the left pedal rewinds the audio playback by a set number of seconds, returning playback to normal forward speed when this operation is completed. Depressing the right pedal similarly advances the playback by a set number of seconds. The middle pedal is used as a pause/play toggle switch, allowing the editor to pause playback to work on a specific section, without losing their place when playback is needed again. The number of seconds that advance or rewind the audio data is adjustable. In some implementations the number of seconds are fixed at a predetermined value and cannot be changed. In some implementations, the controls for the audio playback software can be controlled either with mouse clicks on screen, or using the foot pedals as described, or using keyboard presses or touchscreen presses, or as configured by the transcript editor.

Although the caption editing interface 300 and the transcript editing interface 404 are described as separate systems, it will be recognized that in some implementations, the same physical equipment and/or software may be used both for caption editing and transcript editing. It may be possible for a single work station to be used for either function as necessary. Elements of user interfaces for both the caption editing and transcript editing processes may potentially be selected and customized according to the preferences of a particular user and the features suited to a particular editing task.

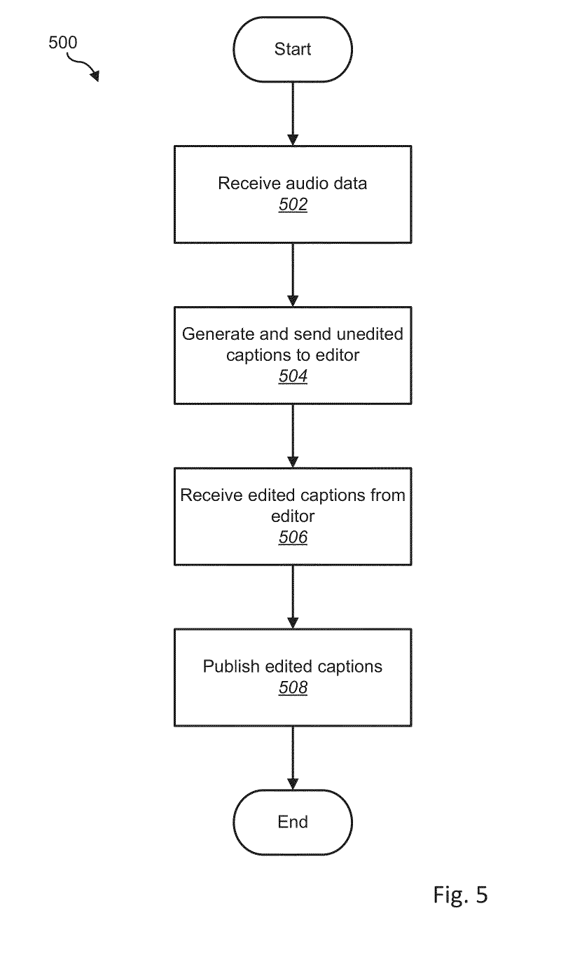

FIG. 5 shows an exemplary method 500 for generating closed captions in accordance with an embodiment of the present disclosure. These steps are described as being executed by a a caption generation system 100 as described above, although it will be understood that other devices may execute steps within the scope of the present disclosure.

Each of the steps associated with the exemplary method 500 may be carried out in conjunction with a live broadcast, and may occur during the live broadcast.

The system receives audio data associated with the live broadcast (502). The audio data may be the original words as spoken during the live broadcast, or may be the words spoken by a re-speaker as described above with respect to FIGS. 1 and 1A. The audio data is received during the live broadcast, and may be processed or further converted into a format for analysis and automated speech recognition (that is, voice-writing or live-writing).

The system analyzes the audio data to generate unedited captions, which it sends to a caption editor (504). The unedited captions may be generated by text recognition software, and in some cases may include injected words or other modifications as described above. The caption editor may be a human user who is receiving and editing captions in real time during the live broadcast.

The system receives edited captions from the editor (506), and publishes the edited captions (508). The system may perform additional modifications and reformatting on the edited captions in order to place them in a form for publication, and as described above, publication may occur on a variety of end-user devices and by a variety of communication protocols. In some implementations, streaming captions may be made available over a network such as the Internet. Further processing may also occur, such as additional language translation or formatting for use on a refreshable braille display.

At this point it should be noted that techniques for live-writing, voice-writing, and editing closed captions in accordance with the present disclosure as described above may involve the processing of input data and the generation of output data to some extent. This input data processing and output data generation may be implemented in hardware or software. For example, specific electronic components may be employed in a control node or similar or related circuitry for implementing the functions associated with live-writing, voice-writing, and editing closed captions in accordance with the present disclosure as described above. Alternatively, one or more processors operating in accordance with instructions may implement the functions associated with live-writing, voice-writing, and editing closed captions in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A computer-implemented method for generating captions for a live broadcast, comprising:
during a live broadcast, receiving audio data, the audio data corresponding to words spoken as part of the live broadcast;
during the live broadcast, analyzing the audio data with speech recognition software in order to generate unedited captions; and
during the live broadcast, generating edited captions from the unedited captions, wherein the edited captions reflect edits made by a user.
